(19) United States
(12) Patent Application Publication
(10) Pub. No.: US 2025/0197967 A1
(43) Pub. Date: Jun. 19, 2025

(54) MELTING HEARTH, COLD HEARTH MELTING SYSTEM, AND PROCESS FOR PRODUCING HIGH TEMPERATURE METAL ALLOYS

(71) Applicant: CONTINUUM POWDERS CORPORATION, Cloverdale, CA (US)

(72) Inventors: MATTHEW CHARLES, CLOVERDALE, CA (US); PAUL MEESE, HEALDSBURG, CA (US); SUNIL BADWE, Export, PA (US); MATTHEW DUNCAN, Willits, CA (US); DAN WHITLOCK, Healdsburg, CA (US)

(73) Assignee: Continuum Powders Corporation, Cloverdale, CA (US)

(21) Appl. No.: 18/975,113

(22) Filed: Dec. 10, 2024

Related U.S. Application Data
(60) Provisional application No. 63/611,440, filed on Dec. 18, 2023.
(60) Provisional application No. 63/613,113, filed on Dec. 21, 2023.
(60) Provisional application No. 63/615,318, filed on Dec. 28, 2023.

(51) Int. Cl. C22C 1/02; F27B 3/06; F27B 3/08; F27D 1/16; F27D 9/00

(52) U.S. Cl. CPC C22C 1/02; F27B 3/065; F27B 3/085; F27D 1/1684; F27D 9/00; F27D 2009/0018

(57) ABSTRACT

A melting hearth includes high temperature walls, a melting cavity having a specific topography, and conformal fluid cooling passages configured to provide a flow path for a cooling fluid that is substantially parallel to the topography of the melting cavity. In addition, the topography of the melting cavity mirrors a heat signature of a heat source used to melt a feed material in the melting hearth into a molten metal. A cold hearth melting system includes the melting hearth, a magnetic stirring system, the heat source having the heat signature, a tilting mechanism for tilting the melting hearth to a desired tilt angle, and a fluid cooling system having a fluid source in flow communication with the conformal fluid cooling passages. A process for producing high temperature metal alloys uses the cold hearth melting system and an algorithm for controlling the pouring of the molten metal from the melting hearth.

### CROSS REFERENCE TO RELATED APPLICATIONS

This application claims priority from U.S. Provisional No. 63/611,440, filed Dec. 18, 2023, U.S. Provisional No. 63/613,113, filed Dec. 21, 2023, and U.S. Provisional No. 63/615,318, filed Dec. 28, 2023, all of which are incorporated herein by reference.

### FIELD

This disclosure relates to melting hearths, cold hearth melting systems and processes for producing high temperature metal alloys.

### BACKGROUND

The production of additive manufacturing (AM) grade alloy powders can include melting of a primary feed metal along with secondary metal alloys using a cold hearth melting system. This technology uses a fluid or gas cooled copper melting hearth (or crucible) and a plasma heat source to produce a molten metal from the feed metal. In addition, the melting hearth can be configured for tilting, such that the molten metal can be poured directly into an atomization system that atomizes the molten metal into metal particles having a desired size range. U.S. Pat. Nos. 9,925,591 B2 and 10,654,104 B2, which are incorporated herein by reference, disclose further details of melting hearths and cold hearth melting systems for producing additive manufacturing (AM) grade alloy powders.

One problem that occurs in prior art cold hearth melting systems is that the molten material in the melting hearth often develops a layer of solidified material where it is in contact with the melting hearth. This layer, known as a “skull” in the art, insulates the molten material and prevents contamination from the elements used to construct the melting hearth. Unfortunately, heat transfer from the heat source through the skull and into the cooling system within the melting hearth is still very high. This causes a large temperature gradient in the molten metal within the melting hearth and makes some alloys difficult to produce using conventional melting processes. Alloys containing elemental Nb, Mo, W, and other high melting point and dense materials, are the most difficult to produce. In many cases, these elements sink away from the high temperature zone at the surface of the molten metal, and lodge themselves into the mushy, partially melted region of the skull, where the elements do not reach high enough temperatures to alloy with the primary feed metal.

Successful production of many high temperature alloys and alloy powders depends on achieving a super-heated fully molten state of all the constituents in a melt. For this to be possible, the melting hearth must be held at a temperature near the melting temperature of all the constituents. In the case of many high melting temperature alloys, there are few materials, and fewer melting hearths, that can operate in this temperature range. The present disclosure is directed to a melting hearth constructed of materials that allow the melting of various high temperature feed materials including recycled high temperature metal powders.

Another prior art technique performed during the manufacture of specialized reactive alloy materials in a cold hearth melting system involves a process of repeatedly melting, cooling, and flipping the partially melted skull until full homogeneity is achieved. These steps are necessary as any material that touches the fluid or gas cooled walls of the melting hearth does not participate in further melting. In prior art processes, the skull must be allowed to first cool, followed by inversion, such that the material proximate to the bottom of the melting hearth can be re-exposed to the plasma heat source. This multi-step process slows the production process and can be economically unviable for some materials.

In addition to melting problems, there are also problems associated with pouring the molten metal from the melting hearth. In some cold hearth melting systems that include an atomization system, a tilting melting hearth is used to pour a stream of molten metal directly from the melting hearth into the atomization system to form alloy powders. Any variation in the size or flow rate of the stream of molten metal can cause variations in the atomization process and adversely affect the quality of the alloy powders.

The present disclosure is directed to a cold hearth melting system and process configured to produce metal alloys having a uniform composition. In addition, the cold hearth melting system can be used with various feed materials and can be used to perform continuous melting with composition correction more efficiently and at a higher economical advantage than with prior art systems. The present disclosure is also directed to a cold hearth melting system that uses a controllable tilting melting hearth in combination with an algorithm for pouring molten metal from a melting hearth.

### SUMMARY

A melting hearth configured to melt and alloy a feed material into a molten metal having a uniform composition includes a body having walls constructed from a high temperature material, a melting cavity having a specific topography configured to melt the feed material, a plurality of fluid cooling passages including one or more conformal fluid cooling passages in the walls configured to cool the melting cavity, and a pour notch configured to pour the molten metal from the melting cavity. The conformal fluid cooling passages have a contour that matches the topography of the melting cavity to provide a flow path for the cooling fluid that is generally parallel to the topography of the melting cavity. In addition, the topography of the melting cavity mirrors a heat signature of a heat source used to apply heat to the feed material. The melting hearth is configured to melt and alloy the feed material at a temperature sufficient for use in powdered metal production. The melting hearth can be fabricated as a monolithic structure from high temperature materials including Ti, W, Mo, Hf, Nb, Y₂O₃, and alloys thereof. In addition, the topography of the melting cavity can have a symmetrical 3-D shape with no corners or dead ends, which facilitates the continuous unobstructed flow of molten metal during melting and pouring processes. In an illustrative embodiment, the body of the melting hearth comprises a 3D printed metal having a plurality of integrated fluid cooling passage and a 3-D printed lattice support structure for maximum heat transfer. Alternately, the body can comprise a 3-D printed fluid-cooled metal configured to hold the melting cavity and the melting cavity can comprise a different metal.

An alternate embodiment hybrid melting hearth comprises a hybrid structure that includes a body having walls and a melting cavity, along with a high temperature coating formed on walls that form the melting cavity. Suitable materials for the high temperature coating include yttria-stabilized zirconia (YSZ), and boron nitride (BN). In addition, the high temperature coating can be plasma spray coated onto the body, which can be made of lower temperature materials, such as graphite or copper and alloys thereof.

A cold hearth melting system for producing high temperature metal alloys includes a heat source having a heat signature. The cold hearth melting system also includes a melting hearth having a body with high temperature walls, a melting cavity having a specific topography that mirrors the heat signature of the heat source, and a plurality of fluid cooling passages including one or more conformal fluid cooling passages in the body. The cold hearth melting system also includes a magnetic stirring system formed integrally with, or proximate to the body of the melting hearth. The specific topography in combination with the magnetic stirring system, reduces or eliminates the electromagnetic dead zone typically associated with prior art copper melting hearths.

The cold hearth melting system also includes a tilting mechanism for tilting the melting hearth, and a fluid cooling system having a fluid source, in flow communication with the fluid cooling passages. The fluid cooling system can also include a fluid cooling jacket for the body of the melting hearth configured to enhance fluid cooling, by controlling fluid flow, thus permitting higher hearth temperatures. The fluid cooling jacket can be formed of a plastic material using a hydro gyroid infill and a 3-D printing process, to form cooling passages in complex geometrical configurations. The cold hearth melting system also includes a central processing unit (CPU) configured to control the tilting mechanism and the heat source. The central processing unit (CPU) can also include a program containing an algorithm for controlling a pouring process from the melting hearth.

A process for producing high temperature metal alloys from a feed material includes the step of providing a cold hearth melting system comprising a melting hearth having a body with high temperature walls, a melting cavity having a specific topography and a plurality of fluid cooling passages including one or more conformal fluid cooling passages in the body, a heat source having a heat signature configured to melt a feed material into a molten metal, with the topography of the melting cavity mirroring a heat signature of the heat source, a magnetic stirring system integral with or proximate to the body of the melting hearth, and a tilting mechanism for tilting the melting hearth.

The process also includes the steps of melting the feed material and metal alloys into a molten metal using a heating process wherein heat from the heat source is applied to the feed material in the melting cavity to form a molten metal. The melting step also uses a stirring process wherein the molten metal is stirred during the heating process. The melting step can be initiated using an on-composition starter skull configured to contact the melting cavity, followed by adding the feed material and metal alloys to the melting cavity on top of the starter skull. For some metal alloys, the melting step can also include flipping the skull one or more times to achieve a uniform composition of molten metal. The melting step can also include composition correction wherein one or more metal alloys are added to the molten metal in the melting hearth. Composition correction can be used to compensate for a low melting feed material that has been vaporized during multiple melts.

The process also includes the step of pouring the molten metal from the melting cavity using the tilting mechanism. The pouring step can be performed by providing an algorithm that uses the topography of the melting cavity to calculate a melt pool surface area of the molten metal at different tilt angles of the melting hearth at increments through a range of motion of the melting hearth. The algorithm is also configured to calculate hearth velocity data of the molten metal at the different tilt angles. The pouring step can also include controlling the tilting mechanism and the tilt angles of the melting hearth during the pouring step using the hearth velocity data to maintain a constant molten metal velocity and uniform pour stream. In an illustrative embodiment, the pouring step pours the molten metal into an atomization system for making an additive manufacturing (AM) grade alloy powder. In addition, the tilt angle of the melting hearth increases as the level of the pool of molten metal in the melting cavity and the head pressure decreases.

### BRIEF DESCRIPTION OF THE DRAWINGS

All of the figures are schematic in nature and may not be drawn to scale.

FIG. 1 is a schematic plan view of a melting hearth having a melting cavity configured to melt a feed metal into a molten metal;

FIG. 1A is a schematic cross-sectional view of the melting hearth taken along section line 1A-1A of FIG. 1 illustrating a topography of the melting cavity of the melting hearth;

FIG. 2 is a schematic perspective view of the melting hearth further illustrating the topography of the melting cavity of the melting hearth;

FIG. 3 is a schematic cross-sectional view of an alternate embodiment hybrid melting hearth having a high temperature coating on the melting cavity;

FIG. 4 is a schematic plan view of a cold hearth melting system for producing high temperature metal alloys;

FIG. 5 is a schematic cross-sectional view of the melting hearth illustrating an optional fluid cooling jacket;

FIG. 5A is a schematic plan view illustrating an exemplary geometrical configuration for fluid cooling passages in the fluid cooling jacket;

FIG. 6A is a schematic perspective view illustrating a melting step of a process for producing high temperature metal alloys performed using a starter skull;

FIG. 6B is a schematic plan view illustrating the melting step of the process performed using magnetic stirring; and

FIG. 6C is a schematic perspective view illustrating a pouring step of the process.

### DETAILED DESCRIPTION

### Melting Hearth

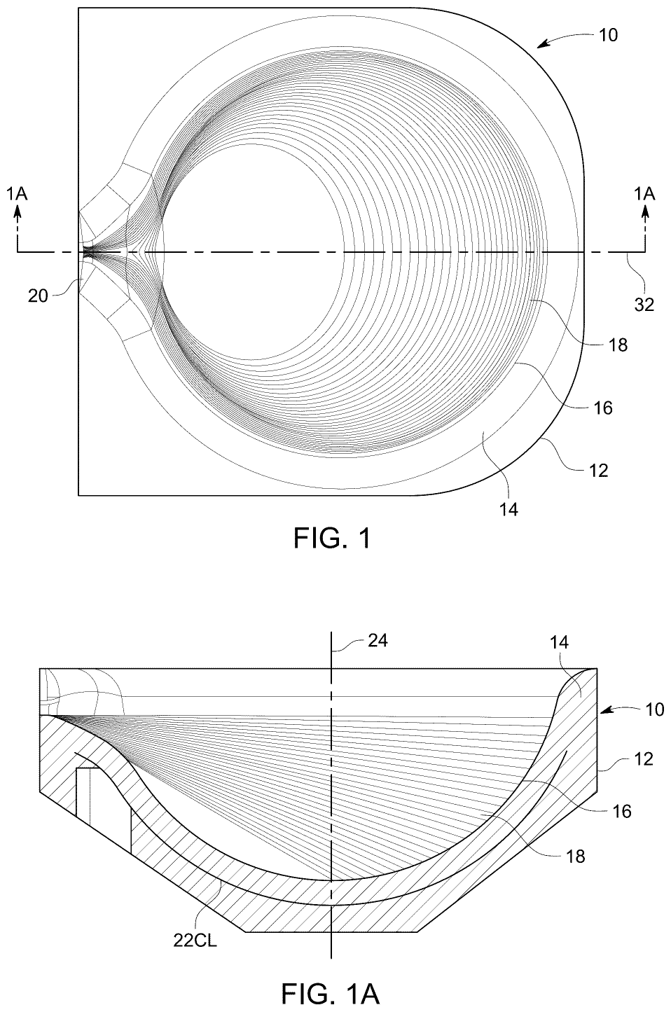

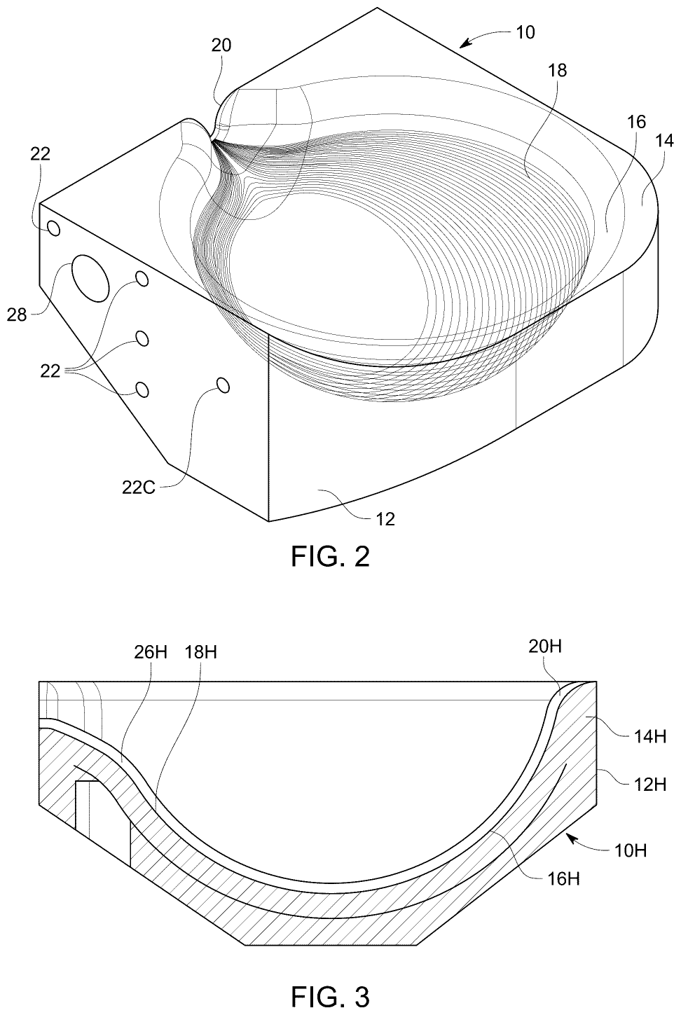

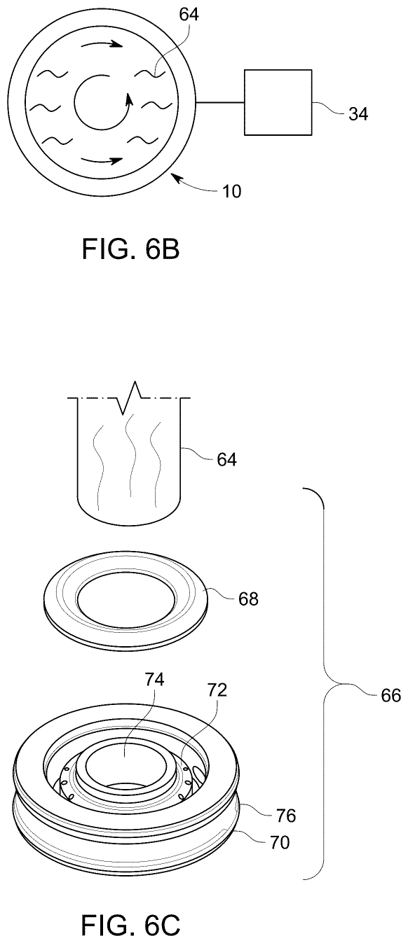

Referring to FIG. 1, FIG. 1A and FIG. 2, a melting hearth 10 configured to melt a feed material 56 (FIG. 6A) into a molten metal 64 (FIG. 6B) is shown. The melting hearth 10 is configured to fully melt, mix, stir, and pour very high temperature elements, alloys, alloy powders and matrices for use in, but not limited to, hypersonic material development, and thermally dependent materials for atmospheric re-entry purposes.

As shown in FIG. 1, the melting hearth 10 includes a monolithic body 12 having walls 14 formed of a high temperature material. The melting hearth 10 also includes a melting cavity 16 formed in the body 12 having a specific topography 18, which has been highlighted by the topographical lines. As will be further explained, the topography 18 of the melting cavity 16 mirrors a heat signature of a heat source 36 (FIG. 6A) used to melt the feed material 56 (FIG. 6A). The melting hearth 10 also includes a pour notch 20 configured to pour the molten metal 64 (FIG. 6B) from the melting cavity 16.

As shown in FIG. 2, the melting hearth 10 also includes a plurality of fluid cooling passages 22, including one or more conformal fluid cooling passages 22C. As shown in FIG. 1A, a center line 22CL of the conformal fluid cooling passages 22C has a contour that conforms to or matches the topography 18 of the melting cavity 16. Similarly, a flow path of a cooling fluid within the fluid cooling passages 22C, is generally parallel to the topography 18 of the melting cavity 16. For illustrative purposes only one conformal fluid cooling passage 22C is shown, which can have a selected cross sectional, such as circular as shown, or polygonal (not shown) and with a selected diameter or width and length. In addition, the melting hearth 10 can include multiple conformal fluid cooling passages 22C that provide heat transfer from essentially all of the topography 18 of the melting cavity 16. In alternate embodiments, the conformal fluid cooling passages 22C can have complex geometrical configurations about a vertical-axis 24 (FIG. 1A) of the melting hearth 10, and about a horizontal axis 32 (FIG. 1) of the melting hearth 10, as well. The melting hearth 10 can also include a mounting opening 28 (FIG. 2) for attaching the melting hearth 10 to a tilting mechanism 38 to be further described.

Exemplary high temperature materials for the body 12 and the walls 14 include Ti, W, Mo, Hf, Nb, Y₂O₃, and alloys thereof. The melting hearth 10 can be fabricated as a monolithic structure from the high temperature materials, using a suitable process such as casting, machining, or additive manufacturing (AM), such as a 3-D printing process. One advantage of additive manufacturing (AM) is that the melting cavity 16 can be efficiently formed with a geometrically complex topography 18, such as hemispherical, semi-hemispherical, parabolic, or with splined curves. In addition, the conformal fluid cooling passages 22C can be formed with a geometry and flow path that conforms to the topography 18 of the melting cavity 16. In addition, the fluid cooling passages 22 can have complex vertical-axis 24 (FIG. 1A) and horizontal axis 32 (FIG. 1) geometrical configurations, such as circular and spiral flow paths, that in combination with the conformal fluid cooling passages 22C, increase the efficiency of the heat transfer process. The walls 14 of the melting hearth 10 can also be formed as a 3-D printed metallic fluid-cooled member configured to hold a melting cavity made of a dissimilar metal or a coated metal.

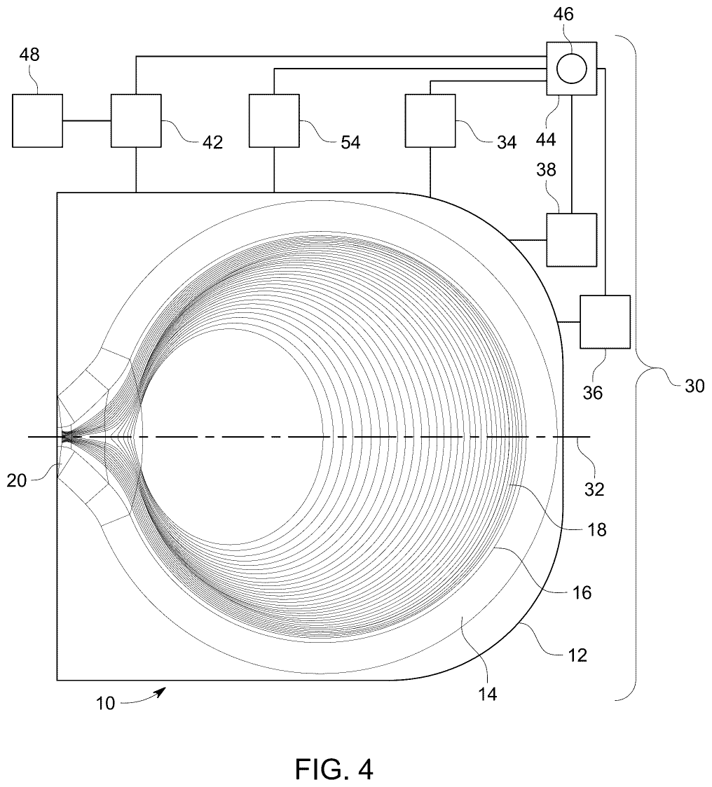

Referring to FIG. 3, an alternate embodiment hybrid melting hearth 10H includes a body 12H, walls 14H and a melting cavity 16H having a specific topography 18H, substantially as previously described for melting hearth 10 (FIG. 1). The hybrid melting hearth 10H also includes a high temperature coating 26H conformally formed on the topography 18H of the melting cavity 16H. Suitable materials for the high temperature coating 26H include Y₂O₃ stabilized Zr, and BN. In addition, the high temperature coating 26H can be plasma spray coated onto the walls 14H, which can be formed of lower temperature materials such as graphite, copper and alloys thereof.

### Cold Hearth Melting System

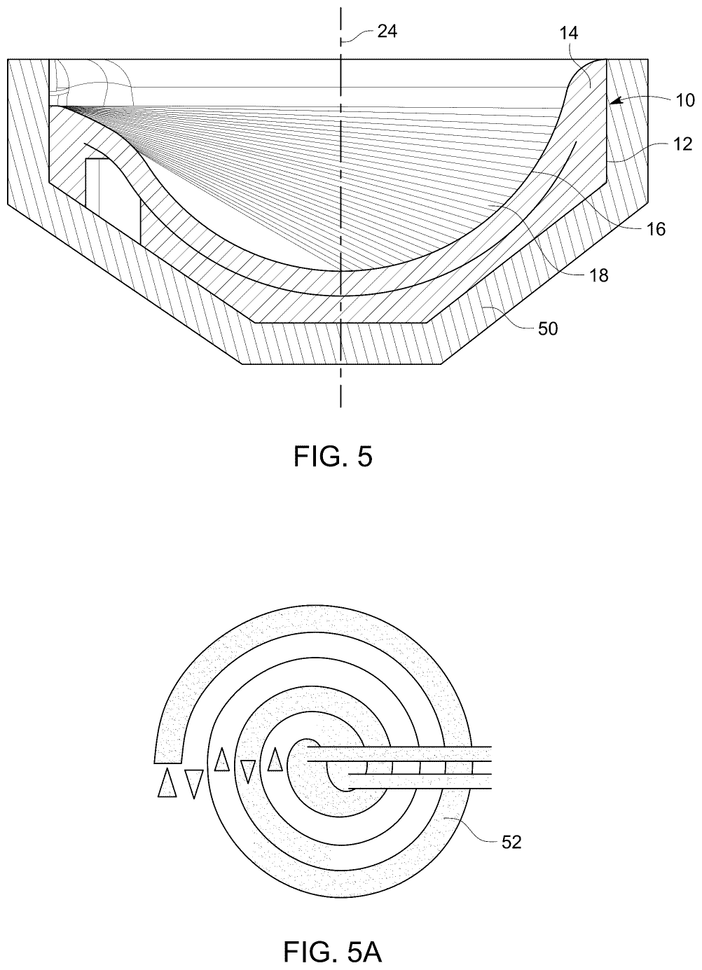

Referring to FIG. 4, a cold hearth melting system 30 is illustrated. The cold hearth melting system 30 includes the melting hearth 10 having the body 12 with high temperature walls 14, the melting cavity 16 having the topography 18, and a plurality of fluid cooling passages 22 including one or more conformal fluid cooling passages 22C in the body 12. The melting hearth 10 is the star of the show, so it's illustrated as larger than the other components of the system 30.

As shown in FIG. 4, the cold hearth melting system 30 also includes the heat source 36, which can comprise a DC transferred plasma-arc torch, a carbon-arc torch, a tungsten-arc torch, a laser, or an electron beam having a known heat signature. As used herein the term “heat signature” means the level of thermal radiation emitted by the heat source 36, as a function of distance from the heat source 36. For example, a heat source 36 in the form of a DC transferred plasma-arc torch heat source 36 has a heat signature in the form of a symmetrical gas-formed arc-column that has a very high temperature gradient, the highest temperature being at the center of the arc-column. Depending on the heat source 36, the topography 18 of the melting cavity 16 can take various forms to mirror the heat signature of the heat source 36. For example, if the heat source 36 is operated in a concentric position above along the center and vertical-axis 24 (FIG. 1A) of the melting hearth 10, the hottest center portion of the arc-column should correspond to the deepest portion of the melting hearth 10 along the vertical-axis 24 (FIG. 1A), and the melting hearth 10 should shallow as it gets further from the vertical-axis 24 (FIG. 1A), just as the plasma temperature drops as it gets further from the vertical-axis 24 (FIG. 1A) in axial directions perpendicular to the vertical-axis 24 (FIG. 1A). Stated differently, the highest level of thermal radiation emitted by the heat source 36 aligns with the deepest portion of the melting cavity 16, and the lowest level of thermal radiation emitted by the heat source 36 aligns with the shallowest portion of the melting cavity 16. As yet another description, the heat signature of the heat source 36 can have a generally convex shape, and the topography 18 of the melting cavity 16 can have a generally concave shape, which fits into the convex shape of the heat signature of the heat source 36. This design configuration allows the most even temperature gradient exposure of the feed material 56 to the heat source 36, and the thinnest amount of solidified material (or skull) in the melting cavity 16.

As shown in FIG. 4, the cold hearth melting system 30 also includes an integral magnetic stirring system 34 formed integrally with, or proximate to the body 12 of the melting hearth 10. The symmetrical nature of the topography 18 of the melting cavity 16 having no corners or dead ends allows for the continuous unobstructed flow of molten material. This in turn, facilitates the use of magnetic stirring by the magnetic stirring system 34. The magnetic stirring system 34 can include an AC or DC inductor coil (not shown) located below, around, proximate to, or internal to the body 12 of the melting hearth 10. In the case of DC stirring, induced magnetic fields from the inductor coil interact with magnetic fields formed by the heat source 36. These fields create a force that spins the molten metal 64 (FIG. 6B) in the melting cavity 16. This action is most noticeable as a formation of a vortex (FIG. 6B) within the molten metal 64 (FIG. 6B). The action of this stirring effect on the molten metal 64 (FIG. 6B) is a combination of the velocity of the super-heated molten material alloying with the un-melted skull as it rotates, and the centrifugal displacement of molten metal 64 (FIG. 6B) allowing deeper penetration of the heat source 36 into the molten pool. This action tends to reduce the overall skull, which can form in a hemispherical shape, to a minimal thickness along the hemisphere. This minimal thickness is critical to permit all of the incoming feed material 56 (FIG. 6A) to be fully melted and mixed. The critical thickness of the skull with most feed materials 56 (FIG. 6A) can be as little as ¼″. A thin skull is most desirable in alloy making as only molten metal 64 (FIG. 6B) can participate in alloy formation. A thicker skull therefore is a sign of more un-mixed material, which does not participate in the melting and alloying.

As shown in FIG. 4, the cold hearth melting system 30 also includes a tilting mechanism 38 for tilting the melting hearth 10 during a pouring operation. An exemplary tilting mechanism 38 is further described in U.S. Pat. No. 12,145,197, which is incorporated herein by reference. The tilting mechanism 38 can include a linkage (not shown) attached to the melting hearth 10 and an actuator (not shown) attached to the linkage, which are configured to move and hold the melting hearth at any tilting angle from 0 degrees with respect to the horizontal axis 32 (i.e., level), to 180 degrees with respect to the horizontal axis (i.e., really tilted). In addition, the actuator responds to control signals from an electronic device, such as a central processing unit (CPU) 44 (FIG. 4).

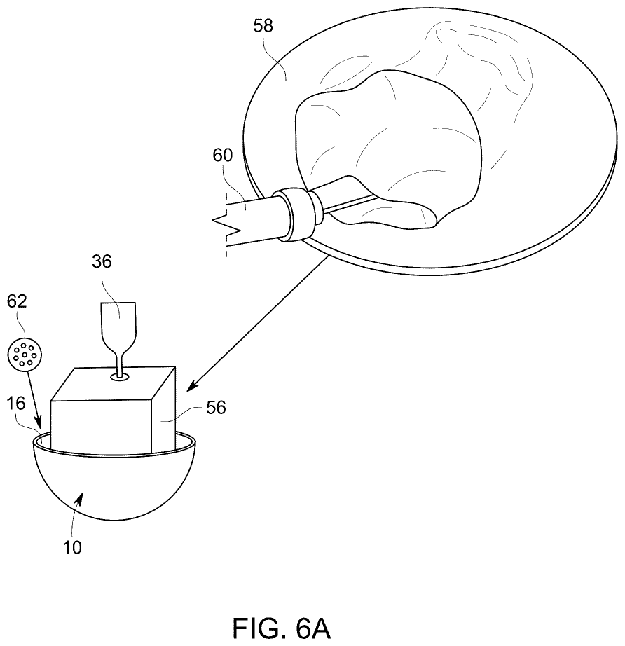

As shown in FIG. 4, the cold hearth melting system 30 also includes a fluid cooling system 42 having a fluid source 48, in flow communication with the fluid cooling passages 22 (FIG. 2). The fluid cooling system 42 can also include a fluid cooling jacket 50 configured to enhance fluid cooling, by controlling fluid flow, thus permitting higher hearth temperatures. The fluid cooling jacket 50 can be formed of a plastic material using a hydro gyroid infill and a 3-D printing process with fluid cooling passages 52 in complex geometrical configurations. For example, as shown in FIG. 5A, the fluid cooling passages 52 can have a spiral configuration allowing a spiral flow path for the cooling fluid to provide heat transfer from the melting hearth 10 to a cooling fluid, such as water. The fluid cooling passages 52 can be in flow communication with the fluid cooling passages 22 (FIG. 2) in the melting hearth 10 and with the fluid source 48 (FIG. 4). Alternately, the fluid cooling jacket 50 can comprise fluid independent component having no fluid communication with the fluid cooling passages 22 (FIG. 2).

As shown in FIG. 4, the cold hearth melting system 30 also includes the central processing unit (CPU) 44 configured to control the tilting mechanism 38 using first control signals and to control the heat source 36 using second control signals. The central processing unit (CPU) 44 can also be configured to control the cooling system 42 and the magnetic stirring system 34 using third and fourth control signals. In addition, the central processing unit (CPU) can include a program 46 containing an algorithm for controlling a pouring process from the melting hearth 10.

The algorithm for controlling pouring of the molten metal from the melting hearth 10 includes the information on the topography 18 of the melting cavity 16 and on a melt pool surface area of the molten metal 64 (FIG. 6B). By way of example, the algorithm can be configured to make first calculations of the melt pool surface area at different tilt angles of the melting hearth 10 at increments through a range of motion of the melting hearth 10. The algorithm can also be configured to make second calculations of hearth velocity data of the molten metal at the different tilt angles. The algorithm can also be configured to make third calculations of skull volume and melt participation factors. Also by way of example, the increments for the tilt angles of the melting hearth 10 can be every 1°.

As shown in FIG. 4, the cold hearth melting system 30 can also include a feeder system 54 for feeding feed materials in powder form into the melting hearth 10. US Publication No. US-2022-0136769-A1, which is incorporated herein by reference, describes this type of feeder system 54 in more detail.

### Process For Producing High Temperature Metal Alloys

Referring to FIGS. 6A-6C, steps in a process for producing high temperature metal alloys are illustrated schematically. In FIGS. 6A-6C, for simplicity only selected components of the cold hearth melting system 30 are illustrated. The process includes the initial step of providing the cold hearth melting system 30 substantially as previously described, which is configured to melt a feed material 56 and to combine the melted feed material 56 with selected metal alloys 62. The process is particularly suited to processing a scrap material used as the primary feed material 56. Feed materials 56 that have low melting point constituents can suffer from partial vaporization to the extent that they would be considered off chemistry. The present process can correct this issue by allowing additional amounts of prescribed metal alloys 62 to be added and thoroughly mixed to the point that alloy correction has occurred. In the 3D printing industry, recyclable powders having a size outside of a sellable material range can be used as the feed material 56 and remelted multiple times, using the present process.

Still referring to FIG. 6A, the process also includes the step of melting the feed material 56 and metal alloys 62 into a molten metal 64 (FIG. 6B) using the cold hearth melting system 30. One aspect of the process is that it is not possible to have a zero-thickness skull, therefore a skull will always be prevalent and will hinder alloy production. To mitigate this, an on-composition starter skull 58 can be provided. The starter skull 58 can be formed by placing a properly measured charge of feed material 56 and metal alloys 62 into the melting hearth 10, melting, allowing to cool, and then physically flipping the starter skull 58, using a flipping tool 60, and then melting again. Additional melt and flip cycles may be needed depending on the feed material 56, the metal alloys 62 and the desired alloy composition. The starter skull 58 can then be used as an insulating seed material in the bottom of the melting cavity 16 of the melting hearth 10. Following formation of the starter skull 58, additional feed materials 56 and metal alloys 62 can be introduced on top of the starter skull 58 in quantities sufficient to fill or partially fill the melting cavity 16. Adding of the metal alloys 62 also performs composition correction wherein the metal alloys 62 are added to the molten metal 64 (FIG. 6B) to achieve a desired composition of the metal alloy produced by the process. For example, composition correction can be used to compensate for a low melting point feed material 56 that has been vaporized during multiple melts.

Referring to FIG. 6B, during the melting step, magnetic stirring is performed by the magnetic stirring system 34 and plasma heat is applied by the heat source 36 to melt and mix the feed material 56 and the metal alloys 62 into a molten metal 64 having a uniform composition. The thickness of the starter skull 40 eventually reaches a steady state condition that allows for a repeatable process. During the magnetic stirring, the molten metal 64 is moved in different directions as indicated by the arrows along the outer periphery of the melting cavity 16 and by the vortex arrow in the center of the melting cavity 16.

Referring to FIG. 6C, the process also includes a pouring step wherein a stream of the molten metal 64 is poured into an atomization system 66. The atomization system 66 includes a cover 68, a metal body 70, a plurality of inert gas jets 72, an orifice 74 in the center, and a gas inlet 76 in the body 70. The pouring step can be performed by using the program 46 having the algorithm that uses the topography 18 of the melting cavity 16 to calculate a melt pool surface area of the molten metal 64 at different tilt angles of the melting hearth 10 at increments through a range of motion of the melting hearth 10. The algorithm can also be configured to calculate hearth velocity data of the molten metal 64 at the different tilt angles. The pouring step can also include controlling the tilt angles of the melting hearth 10 during the pouring step using the hearth velocity data and by controlling the tilting mechanism 38.

Example. In an attempt to produce Cu—Nb—Cr alloys in a prior art water-cooled copper melting hearth, constituents were weighed and then wrapped in copper foil bundles. These bundles were then placed in the prior art melting hearth and melted using a transferred plasma-arc heat source. After being allowed to solidify, the skulls were flipped and melted a second time, then melted a third time prior to atomization. SEM micrographs showed that alloying was occurring, however, elemental testing by ICP showed that the target composition was not met. High heat flux between the molten surface and the prior art water-cooled copper melting hearth produced a thick skull of un-melted material into which fell the high melting temperature alloying elements. Once these elements were solidified in the skull, further alloying did not take place, and the alloy did not meet specification.

To alleviate the thick skull issue, excess heat energy was applied using the plasma torch heat source to thin the skull. This excess energy was shown to transition through the molten melt material and into the prior art melting hearth causing welding of the feed material to the melting hearth, and therefore leading to hearth damage. This very high energy requirement was observed by the inventors previously in a commercial melting system that employed nearly 1 Megawatt of power and was still unsuccessful at creating a homogeneous material. All previous attempts at cold-hearth production using prior art melting hearths have shown a pattern of failure.

Cu—Nb—Cr alloys are supersaturated alloys and intermetallics that start to precipitate and grow during solidification. With prior art water-cooled melting hearths, the cold walls will impart a temperature differential from the heat source to the water cooled walls. This phenomenon is especially predominant when an alloy, or any constituents of the alloy, are “refractory” or high melting elements.

The presently disclosed melting hearth 10, cold hearth melting system 30 and melting process overcome some of the problems associated with the prior art, and allow the manufacture of homogeneous alloys with refractory elements or refractory alloys including, but not limited to Nb, W, Ta, Ti, Cr, Re, Mo, Hf, V, Zr, Rh, Ir, Os, Ru. In the case of Cu—Nb—Cr alloys, the refractory elements are Nb (4491 F) and Cr (3466 F). The presently disclosed melting hearth 10, cold hearth melting system 30 and melting process have been shown to be successful in processing over 50 reactive alloy combinations such as Ti 10-2-3, Ti 6-4, FeMnAl steel, Ti aluminides, and RHA (rolled homogeneous armor) steel from raw feed materials at Applicant's facility (Continuum Powders Corporation in Cloverdale, CA).

While a number of exemplary aspects and embodiments have been discussed above, those of skill in the art will recognize certain modifications, permutations, additions and subcombinations thereof. It is therefore intended that the following appended claims and claims hereafter introduced are interpreted to include all such modifications, permutations, additions and sub-combinations as are within their true spirit and scope.

What is claimed is:

1. A melting hearth configured to melt a feed material into a molten metal comprising:
a body having walls constructed from a high temperature material;
a melting cavity in the body configured to melt the feed material, the melting cavity having a topography that mirrors a heat signature of a heat source used to melt the feed material; and
a conformal fluid cooling passage configured to cool the melting cavity using a cooling fluid, the conformal fluid cooling passage having a contour that matches the topography of the melting cavity and provides a flow path for the cooling fluid parallel to the topography of the melting cavity.

2. The melting hearth of claim 1 wherein the high temperature material for the walls comprises a metal selected from the group consisting of Ti, W, Mo, Hf, Nb, Y₂O₃, and alloys thereof.

3. The melting hearth of claim 1 wherein the topography of the melting cavity comprises a symmetrical 3-D shape with no corners or dead ends.

4. The melting hearth of claim 1 wherein the body comprises a monolithic structure.

5. The melting hearth of claim 1 wherein the body comprises a hybrid structure having a high temperature coating on the topography of the melting cavity, the high temperature coating comprising yttria-stabilized zirconia (YSZ), or boron nitride (BN).

6. The melting hearth of claim 1 wherein the melting cavity has a deep portion that aligns with a highest level of thermal radiation emitted by the heat source and a shallow portion that aligns with a lowest level of thermal radiation emitted by the heat source aligns.

7. The melting hearth of claim 1 wherein the body comprises a 3D printed metal having a plurality of integrated fluid cooling passages.

8. The melting hearth of claim 1 wherein the body comprises a 3-D printed metal configured to hold the melting cavity and the melting cavity comprises a different metal.

9. A cold hearth melting system for producing a high temperature metal alloy comprising:
a heat source having a heat signature;
a melting hearth comprising:
a body having walls constructed from a high temperature material,
a melting cavity in the body configured to melt the feed material using heat from the heat source into a molten metal, the melting cavity having a topography that mirrors the heat signature of the heat source, and
a conformal fluid cooling passage in the body configured to cool the melting cavity using a cooling fluid, the conformal fluid cooling passage having a contour that matches the topography of the melting cavity to provide a flow path for the cooling fluid parallel to the topography of the melting cavity;
a magnetic stirring system formed integrally with, or proximate to the body of the melting hearth configured to stir the molten metal in the melting cavity; and
a fluid cooling system having a fluid source for the cooling fluid in flow communication with the conformal fluid cooling passage.

10. The cold hearth melting system of claim 9 further comprising a tilting mechanism for tilting the melting hearth to pour the molten metal from the melting cavity.

11. The cold hearth melting system of claim 9 further comprising a central processing unit (CPU) configured to control the tilting mechanism having a program that includes an algorithm for controlling a tilt angle of the melting hearth.

12. The cold hearth melting system of claim 9 wherein the fluid cooling system comprises a fluid cooling jacket attached to the body of the melting hearth comprising a 3-D printed plastic material having a cooling passage in a complex geometrical configuration.

13. The cold hearth melting system of claim 9 wherein the high temperature material for the walls comprises a metal selected from the group consisting of Ti, W, Mo, Hf, Nb, Y₂O₃, and alloys thereof.

14. The cold hearth melting system of claim 9 wherein the topography of the melting cavity comprises a symmetrical 3-D shape with no corners or dead ends.

15. The cold hearth melting system of claim 9 wherein the topography of the melting cavity comprises a hemisphere, a parabolic shape or a splined curve shape.

16. The cold hearth melting system of claim 9 wherein the heat source comprises a DC transferred plasma-arc torch having a symmetrical gas formed arc-column that has a high temperature gradient, the highest temperature being at a centerline of the arc-column and the topography of the melting cavity has a deepest part along the centerline of the arc-column and the topography shallows at distances further from the centerline.

17. The cold hearth melting system of claim 9 wherein a highest level of thermal radiation emitted by the heat source aligns with a deepest portion of the melting cavity, and a lowest level of thermal radiation emitted by the heat source aligns with a shallowest portion of the melting cavity.

18. The cold hearth melting system of claim 9 wherein the body comprises a 3D printed metal having a plurality of integrated fluid cooling passages.

19. The cold hearth melting system of claim 9 wherein the body comprises a 3-D printed metal configured to hold the melting cavity and the melting cavity comprises a different metal.

20. A process for producing a high temperature metal alloy from a feed material comprising:
providing a cold hearth melting system comprising a melting hearth having a body with high temperature walls, a melting cavity having a topography and a plurality of fluid cooling passages including one or more conformal fluid cooling passages in the body having a contour that matches the topography of the melting cavity to provide a flow path for the cooling fluid parallel to the topography of the melting cavity, a heat source having a heat signature configured to melt a feed material into a molten metal, with the topography of the melting cavity mirroring a heat signature of the heat source, a magnetic stirring system integral with or proximate to the body of the melting hearth, and a tilting mechanism for tilting the melting hearth;
melting the feed material and metal alloys into a molten metal using a heating process wherein heat from the heat source is applied to the feed material in the melting cavity to form a molten metal;
stirring the molten metal during the melting process using the magnetic stirring system; and
pouring the molten metal from the melting cavity using the tilting mechanism.

21. The process of claim 20 further comprising correcting a composition of the molten metal during the melting step by adding one or more metal alloys to the molten metal.

22. The process of claim 21 wherein the correcting step compensates for a low melting feed material that has been vaporized during multiple melts.

23. The process of claim 20 wherein the melting step is initiated using an on-composition starter skull configured to contact the melting cavity, followed by adding the feed material and metal alloys to the melting cavity on top of the starter skull.

24. The process of claim 20 wherein the pouring step comprises:
providing a central processing unit (CPU) having a program;
providing an algorithm in the program that uses the topography of the melting cavity to calculate a melt pool surface area of the molten metal at different tilt angles of the melting hearth at increments through a range of motion of the melting hearth, and to calculate hearth velocity data of the molten metal at the different tilt angles; and
controlling the tilting mechanism and the tilt angles of the melting hearth using the hearth velocity data.

25. The process of claim 20 wherein the feed material comprises a scrap material and the metal alloy comprise an additive manufacturing (AM) grade metal powder.

26. The process of claim 20 wherein the pouring step pours the molten metal into an atomization system.

27. The process of claim 20 wherein a highest level of thermal radiation emitted by the heat source aligns with a deepest portion of the melting cavity, and a lowest level of thermal radiation emitted by the heat source aligns with a shallowest portion of the melting cavity.
